(19) United States
(12) Patent Application Publication
(10) Pub. No.: US 2018/0191651 A1
(43) Pub. Date: Jul. 5, 2018

(54) TECHNIQUES FOR AUGMENTING SHARED ITEMS IN MESSAGES

(71) Applicant: Facebook, Inc., Menlo Park, CA (US)

(72) Inventors: Jeremy Harrison Goldberg, San Francisco, CA (US); Jessica Lee, Menlo Park, CA (US); Lindsay Reynolds, San Carlos, CA (US); Christopher Bing Chen, San Francisco, CA (US); Joseph Anton Lajavic, Mountain View, CA (US)

(21) Appl. No.: 15/394,143

(22) Filed: Dec. 29, 2016

(51) Int. Cl. H04L 12/58

(52) U.S. Cl. CPC H04L 51/08

(57) ABSTRACT

A computer-implemented method may include detecting a shared item in a message from a sharing user account to one or more receiving user accounts; matching the shared item to an entity; determining an augmentation element associated with the entity; generating an augmented shared item by augmenting the shared item with the augmentation element; and sending the augmented shared item to one or more receiving client devices associated with the one or more receiving user accounts. Other embodiments are described and claimed.

### BACKGROUND

Mobile client devices are used extensively to communicate among their users. The exchange of messages, including text, images, video, and links to online resource and content is also extensive. In some cases, the sharing of items may prompt an action on behalf of the recipient. It is with respect to these and other considerations that the present improvements are needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments provide techniques for augmenting shared items in a messaging system. Some embodiments are particularly directed to techniques for matching shared items to entities in a social network and augmenting the shared items with display or control elements associated with the entity.

In one embodiment, for example, a computer-implemented method may include detecting a shared item in a message from a sharing user account to one or more receiving user accounts; matching the shared item to an entity; determining an augmentation element associated with the entity; generating an augmented shared item by augmenting the shared item with the augmentation element; and sending the augmented shared item to one or more receiving client devices associated with the one or more receiving user accounts. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an execution system for a communication system.

FIG. 2 illustrates an embodiment of the communication system of FIG. 1.

FIG. 3 illustrates an embodiment of a client device for the system of FIG. 1.

FIG. 4 illustrates an embodiment of a augmentation system for the system of FIG. 1.

FIG. 5 illustrates an embodiment of a messaging system for the system of FIG. 1.

FIG. 6 illustrates an embodiment of a user interface for the system of FIG. 1.

FIG. 7 illustrates an embodiment of a second user interface for the system of FIG. 1.

FIG. 8 illustrates an embodiment of a third user interface for the system of FIG. 1.

FIG. 9 illustrates an embodiment of a message flow for the system of FIG. 1.

FIG. 10 illustrates a diagram of a social graph for the system of FIG. 1.

FIG. 11 illustrates a diagram of a centralized system for the system of FIG. 1.

FIG. 12 illustrates a diagram of a distributed system for the system of FIG. 1.

FIG. 13 illustrates an embodiment of a logic flow for the system of FIG. 1.

FIG. 14 illustrates an embodiment of a computing architecture.

FIG. 15 illustrates an embodiment of a communications architecture.

FIG. 16 illustrates an embodiment of a device for use in a multicarrier OFDM system.

### DETAILED DESCRIPTION

Various embodiments are generally directed to techniques for augmenting shared items in a messaging system. Some embodiments are particularly directed to techniques for adding information and control elements to a shared item from one or more entities related to the shared item in some way.

When a user shares a photo, a video, a link to a product, or other items in a messaging application, the recipient may wish to take an action related to the shared item. For example, the recipient user may wish to know where the sender was when a photo was taken, what product the sender purchased, where the recipient can obtain a product, or purchase tickets to an event. Conventionally, the user who wishes to take action must leave the messaging environment and search for the additional information and services on their own, perhaps by using other applications on their devices. Accordingly, embodiments presented herein provide methods for presenting shared items to a recipient user with augmentation related to the shared item and an entity, e.g. a business, that is related to the shared item.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to an apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct a more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

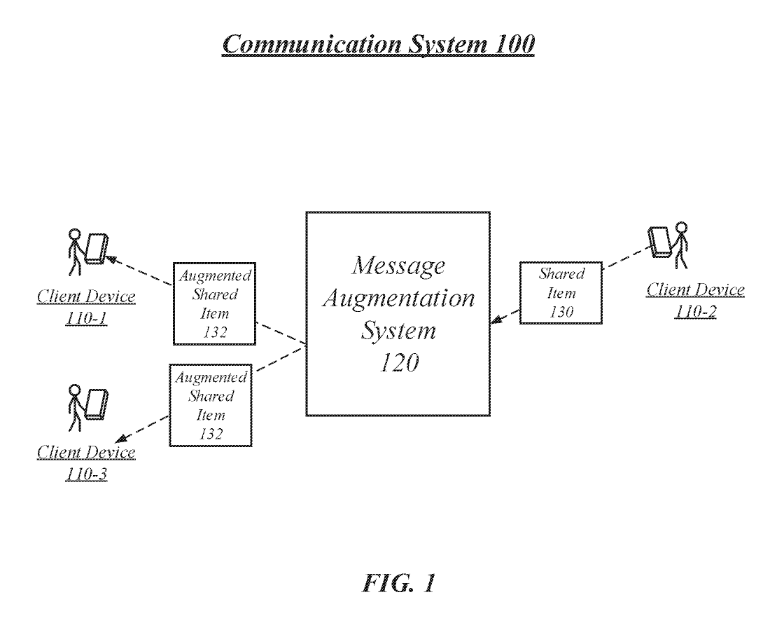

FIG. 1 illustrates a block diagram for a communication system 100 for augmenting shared items communicated among users and client devices of the system. In one embodiment, the system 100 may comprise a computer-implemented system 100 having a client device 110-1 operated by a first participant, a client device 110-2 operated by a second participant, one or more additional client devices 110-3 operated by additional participants, and a message augmentation system 120, each comprising one or more components. Although the system 100 shown in FIG. 1 has a limited number of elements in a certain topology, it may be appreciated that the system 100 may include more or fewer elements in alternate topologies as desired for a given implementation.

As shown in FIG. 1, the participants may be communicating by exchanging messages. A message may include a shared item 130. A shared item may include, for example and without limitation, text, an image, a video, an audio recording, a link, a file, and so forth.

In addition, the system 100 may include a message augmentation system 120. The message augmentation system 120 may coordinate the exchange of messages and shared items between two or more participants such as client devices 110-1 and 110-2. The message augmentation system 120 may augment the shared item 130 to create an augmented shared item 132.

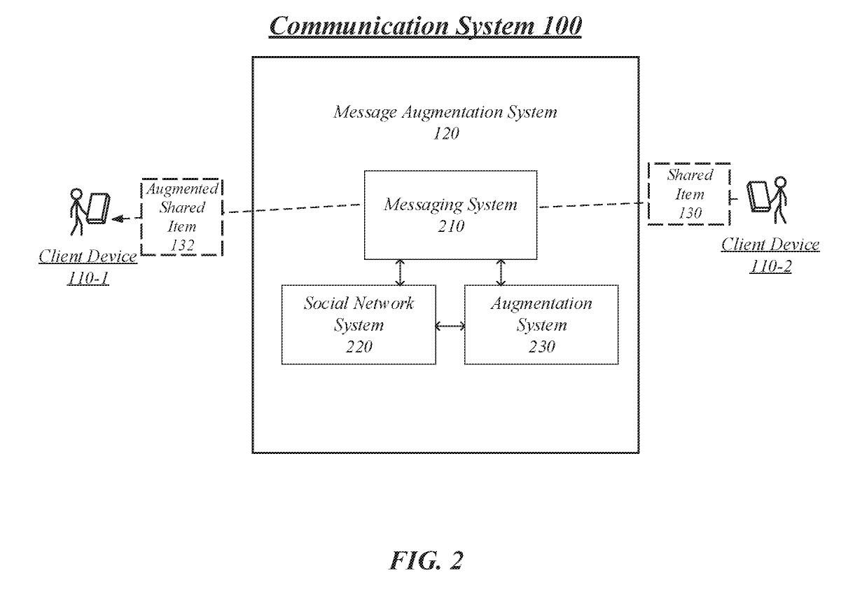

An augmented shared item 132 may include the shared item 130 and augmentation elements in the form of display elements and/or control elements. The augmentation elements may provide additional information related to the shared item 130, e.g. as display elements. The augmentation elements may provide the user with selectable options, e.g. control elements, to engage with an entity associated with the shared item. The augmentation elements may be presented as an overlay to the shared item. The message augmentation system 120 may be embodied in a single device or with multiple devices and is described further with respect to FIGS. 2, 4, and 5.

A client device 110 may be any electronic device capable of, at least, receiving audio data and/or recording audio data from a microphone, outputting audio data to the sender, and communicating with other devices to exchange data and instructions over a network. The client device 110 may communicate with other devices using wireless transmissions to exchange network traffic. Exchanging network traffic, such as may be included in the exchange of shared item 130, may comprise transmitting and receiving network traffic via a network interface controller (NIC). A NIC comprises a hardware component connecting a computer device, such as client device 110, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API).

The client device 110 may perform various operations using network data accessed over a network. The client device 110 may access a cellular system using cellular signals (not shown). The client device 110 may access one or more Wi-Fi access points using Wi-Fi signals (not shown).

A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for augmenting shared items in a messaging system is next provided.

FIG. 2 illustrates an embodiment of the communication system 100 of FIG. 1 and may represent a more detailed view of the communication system 100. Although the system 100 shown in FIG. 2 has a limited number of elements in a certain topology, it may be appreciated that the system 100 may include more or fewer elements in alternate topologies as desired for a given implementation.

As shown in FIG. 2, the message augmentation system 120 may include one or more subsystems, such as a messaging system 210, a social network system 220, and an augmentation system 230. More, fewer, or alternate subsystems may be used. Each subsystem may be owned and operated by the same entity. In some embodiments, one or more of the subsystems may be owned and operated by a different entity from the other subsystems.

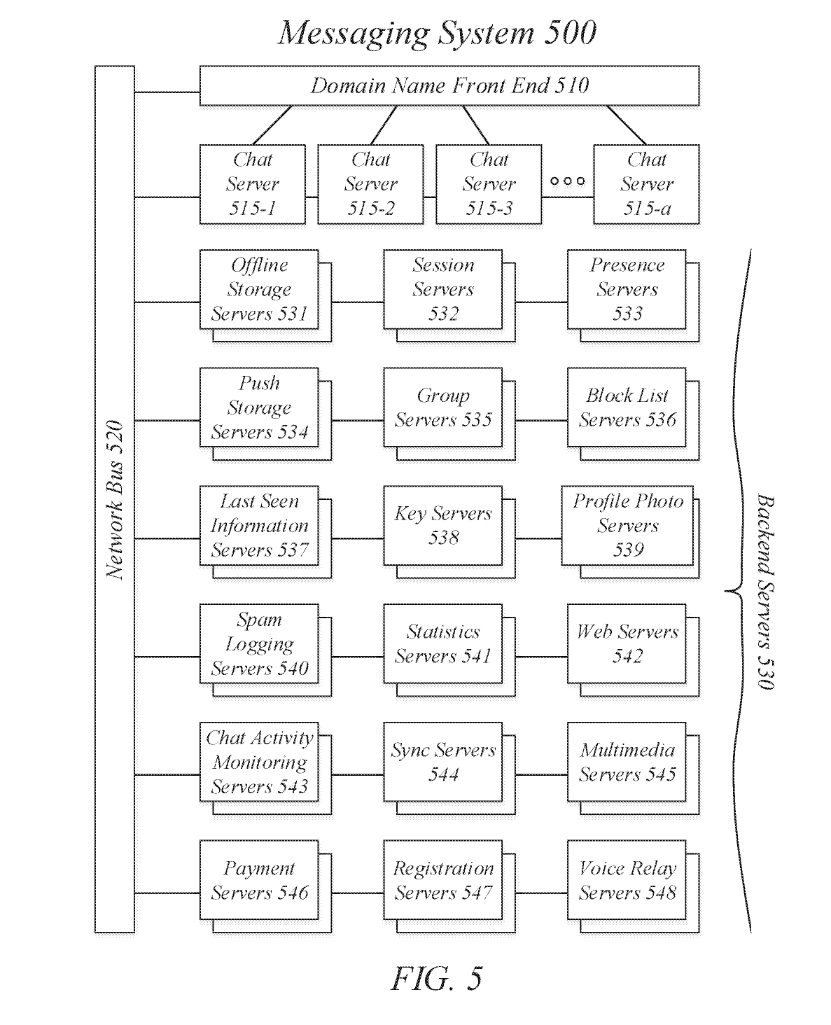

The messaging system 210 may provide the functions, operations and infrastructure to allow client devices 110 to send and receive messages to and from each other. The messages may contain text, images, video, links or addresses to network resources, audio recordings, files, and so forth. An exchange of messages may be between two users or among a group of users. An embodiment of the messaging system 210 is described in more detail with respect to FIG. 5.

The social network system 220 may enable one or more users (e.g., persons, businesses, and other entities) to interact with each other in the social networking system by providing social networking services to the one or more users. Each user of the social network system 220 may be associated with a user account in the social network system 220. Each user account may be represented by user account information. The user account information for each user may include, but is not limited to, user account identifier (e.g., phone number, email address, etc.), user account authentication token (e.g., user account password, physical and/or virtual security tokens, etc.), and/or any other information relevant to the authentication and authorization of each user. To ensure authorized access of each user, the social network system 220 may be further configured to authenticate each user based on at least a portion of the user account information (e.g., user account identifier, user account authentication token) provide by each user and received from one or more devices 110.

Each user account may be further associated with a user profile representative of a user's presence within the social network system 220. Each user profile associated with each user may be represented by user profile information, which may include, but is not limited to, user identifier information (e.g., a unique identifier that identifies the user and the user profile information), user biographic and/or demographic information, (e.g., user name information which may include, but is not limited to, a first, middle, and/or last name of the user, an entity name associated with the user, contact information of the user, birth date of the user), user profile media information (e.g., profile image(s) of the user, a focused user profile image of the user, etc.), user location information (e.g., the hometown location of the user, the current location of the user), user time zone information (e.g., time zone of the user, etc.), user social connections information (e.g., a list of friends, family members, coworkers, teammates, classmates, business associates, of the user), user groups membership information, user interest information (e.g., the interests listed by the user, movies listed by the user, music listed by the user, books listed by the user, approvals or “likes” of the user, or any other information that may identify the user's interest), user employment history information (e.g., list of current and/or past employers of the user), user social message information (e.g., one or more social networking messages where the user is a recipient), and/or any other preference/personal information associated with the user.

To provide users with one or more social networking services, the social network system 220 may store one or more social networking objects representative of the information received and provided by the social network system 220. Furthermore, the social networking objects of the social network system 220 may include, but is not limited to, events, user profiles, comments, activities (e.g., posts, polls, etc.), groups, media (e.g., images, videos, illustrated graphical objects, e.g., “Stickers,” animated images, files, applications, etc.), or any other social networking object that may be received, stored, provided, or otherwise tracked and/or accessed by the social network system 220.

The social network system 220 may further store object connections between two or more objects. Furthermore, the object connections may be representative of the relationship or links between the two or more objects. The one or more social networking objects in conjunction with one or more object connections may form a social graph comprising two or more nodes interconnected via one or more edges, where each node may be representative of a social networking object and each edge may be representative of the object connections between two or more social networking objects in the social network system 220.

The social network system 220 may also enable users to send and/or receive private social messages to one or more users by communicating the social message information comprising one or more private social messages to and from one or more users. The social network system 220 may use the messaging system 210 to enable the exchange of private social messages.

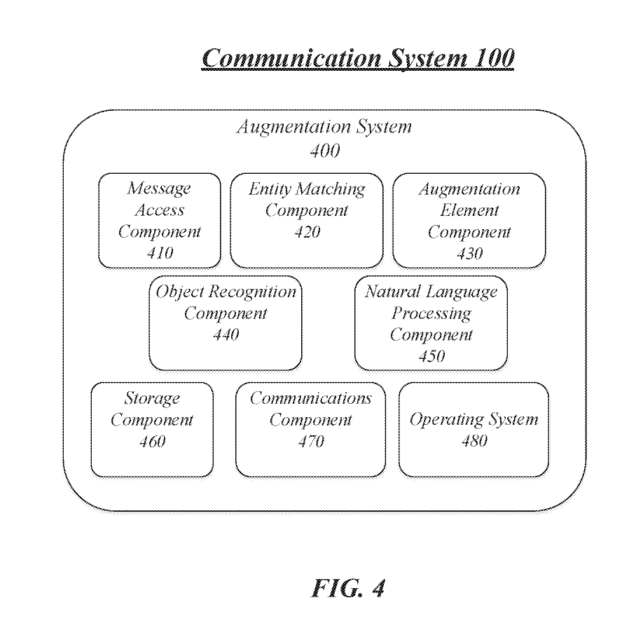

The augmentation system 230 may be able to access messages exchanged via the messaging system 210, subject to privacy settings, and augment shared items found in the messages. For example, when a shared item is an image, the augmentation system 230 may be able to extract location information associated with the image and present information about a social network entity having a location in the vicinity of the location in the image. The augmentation system 230 may be able to perform object recognition on the image to identify the subject of the image, and may be able to present information about a social network entity related to the subject of the image that occurs within a vicinity of the client device that sent or is receiving the image. The augmentation system 230 may be able to identify a network service related to a shared link and may be able to provide control elements that allow a user to access the network service. An embodiment of the augmentation system 230 is described in more detail with respect to FIG. 4.

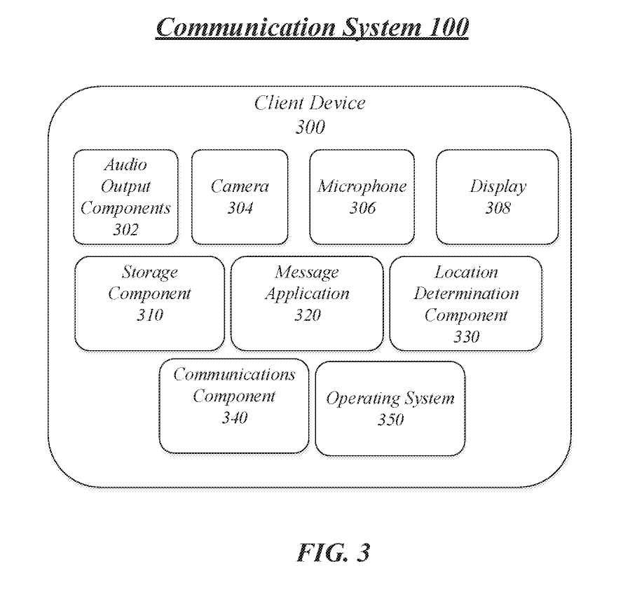

FIG. 3 illustrates an embodiment of a client device 300 for the system of FIG. 1. The client device 300 may be an embodiment of client device 110. The client device 300 may include various hardware components and software components. The hardware components may include various audio output components 302, a camera 304, a microphone 306, and a display component 308. Other hardware components may also be included, such as various other input components, e.g. a keyboard or keypad, as well as a global positioning system (GPS) component, an altimeter, and so forth.

The audio output components 302 may include any components operative to output sound waves, such as an earpiece speaker, a loudspeaker, and/or an audio-out connection. The audio output components 302 may include hardware and/or software that converts between analog and digital sound data.

The camera 304 may be a camera integrated into the client device 300 that can take digital photographs through a lens and store the digital photos. The camera 304 may also operate as a video camera that can record video data for storage and/or transmission during a video call.

The microphone 306 may be any device capable of receiving sound waves, e.g. spoken by a human operator, and converting the received sound waves into electrical signals and/or data that can be stored and transmitted to other devices. The microphone 306 may be integrated into the client device 300, or may be an external microphone coupled to the client device 300 wirelessly or through an external wired connection. The microphone 306 may be for example, a component of a head-set, earpiece, or other hands-free communication device that communicates with the client device 300 via a short-range signal technology such as BLUETOOTH® technology. The embodiments are not limited to this example.

The display component 308 may include any interface components capable of presenting visual information to the operator of the client device 300, such as, but not limited to, a screen for visual output including image or video data received as part of a message communication, e.g. as an augmented shared item 132.

The client device 300 may further include a storage component 310 in the form of one or more computer-readable storage media capable of storing data and instructions for the functions of software, such as a message application component 320, and an operating system 350. As used herein, “computer-readable storage medium” is not intended to include carrier waves, or propagating electromagnetic or optical signals.

The client device 300 may include various software components, such as a message application component 320. The message application component 320 may comprise instructions that when executed by a processing circuit (not shown) cause the client device 300 to perform the operations of the message application component 320 as will be described herein. Generally, the message application component 320 may be provided on the client device 300 at the time of purchase, or may installed by the sender, and may enable the creation, communication, and playback of communication in a variety of formats, including, but not limited to, real-time audio, audio messages, text, real-time video, and video recordings.

The message application component 320 may be software and/or a combination of software and hardware operating on any electronic device capable of sending and receiving messages, including shared items 130 to and from the client device 110.

The message application component 320 may allow a user to communicate with others, e.g. with other users, by sending and receiving messages from one client device to one or more others. The message application component 320 may be, for example, and without limitation, an electronic mail application, a short-message-service (SMS) message application, a multimedia-message-service (MMS) message application, a group communication application, a telephone voicemail system application, a video-communication application, and so forth. The message application component 320 may be a message application that provides multiple modes of communication, including but not limited to, alphanumeric text, real-time voice calls, real-time video calls, multimedia messages, data representing special effects, and so forth. The message application component 320 may be a social network application that allows its members to communicate with messages. The message application component 320 may accept an address for a recipient, such as an e-mail address, a chat handle, a telephone number, a user name within a social network service, and so forth.

The client device 300 may include a location determination component 330. The location determination component 330 may include software and/or hardware elements that determine a physical location of the client device 330. The location determination component 330 may determine the location in a variety of ways, for example, using a GPS component, proximity to a WiFi base station having a known location and range, proximity to one or more cellular service transmitters having known locations and ranges, and so forth.

The client device 300 may include a communications component 340. The communications component 340 may include one or more hardware and/or software components that allow the transmission and receiving of signals by the client device 300. The communications component 340 may include the hardware and/or instructions to communicate on a data network, such as over a long-term evolution (LTE) network; a shorter-range network, such as by Wi-Fi or by BLUETOOTH; a cellular telephone network; and/or a peer-to-peer network.

FIG. 4 illustrates an embodiment of an augmentation system 400 for the system of FIG. 1. The augmentation system 400 may be an embodiment of the augmentation system 230. The augmentation system 400 may operate on one or more server computing devices, and may include hardware elements such as a storage component 460 and a communications component 470. The augmentation system 400 may use an operating system 480. The storage component 460, communications component 470, and operating system 480 may be similar or analogous to the storage component 310, communications component 340, and operating system 350, respectively.

The augmentation system 400 may include one or more functional components that execute to provide the operations described herein. The functional components may be implemented in software, hardware, or a combination, and may include, for example, a message access component 410, an entity matching component 420, an augmentation element component 430, an object recognition component 440, and a natural language processing (NLP) component 450. More, fewer, or different functional elements may be used to provide the same or similar operations. In an embodiment, some of the functional elements may be combined into one functional element.

The message access component 410 may detect a shared item in a message sent from a sharing user account to one or more receiving user accounts. The message access component 410 may, subject to privacy settings, examine each message received at the messaging system 210, or may receive shared items in messages identified by the message system 210. A shared item may include, for example, a link to a website or a network resource, a photograph or other image, a media item such as an audio recording or a video recording, a file, or a text message.

In an embodiment, the sender and recipient user accounts may be associated with human users sharing information via the augmentation system 400. In another embodiment, the sender or the recipient accounts may be associated with a logical construct, for example, the recipients may be broadcast recipients rather than direct message recipients. In some cases, broadcast recipients may be specified by the sender, such as with a broadcast recipient list specifying a list of recipient users to receive a message. In other cases, broadcast recipients may be self-selected, such as where one or more users subscribe to receive broadcast messages from a particular sender, with the list of recipients determined according to a subscriber list for the sender. Subscriber lists for the senders may be specific to particular topics, such as specifically subscribing to user-generated media montages, regular broadcast updates, updates on a specific subject, or according to any other technique. In some cases, multiple recipients may be used for a message where the message is distributed as part of a group message thread. A sender or recipient may be a publication, such as a web page, a feed, a blog, and so forth. Some messages, including broadcast messages, which may include group messages, may be ephemeral, such that they are automatically removed after a defined time period of either sending or being viewed.

The entity matching component 420 may match the shared item to an entity. An entity may be a person, a business, a government agency, a software application, a service, an object of commerce, or any other object or construct that can be represented in the social network system 220. The entity matching component 420 may request entity information from the social network system 220. In an embodiment, the entity matching component 420 may provide an element to the social network system 220 and request that the social network system 220 perform a search for an entity matching the element. In another embodiment, the entity matching component 240 may access a social graph of the social network system 220 and search directly.

Matching a shared item to an entity may include identifying some relationship between the shared item and an entity. In an embodiment, a location associated with the shared item and a location associated with an entity may cause the shared item to be matched to the entity when their respective associated locations match or are in each other's vicinity. The entity matching component 420 may be able to retrieve or extract a geolocation metadata tag from shared photo item or from the sending or receiving devices, and match the extracted location to an entity's location. In an embodiment, the shared item may be, or include, a link, and a domain name in the link may be matched to a domain of an entity. In an embodiment, the shared item may be an operation or action taken on a client device, and an entity may be matched when the entity is associated with the operation or action.

In some embodiments, the entity matching component 420 may not have direct access to an element of the shared item that would allow matching to an entity. For example, an image may not have location data. The entity matching component 420 may submit the shared image item to the object recognition component 440 and receive one or more elements, such as words related to the object(s) in the image, for use in entity matching.

Likewise, when the shared item is text, the entity matching component 420 may submit the shared text message to the natural language processing component 450. The entity matching component 420 may receive one or more elements, such as keywords or intents related to the text, for use in entity matching.

When a shared item is a product, the product may be associated with a plurality of business entities in the social network system 220. The entity matching component 420 may select a particular business entity for matching based on business promotion purchase registration for the business entity. That is, a business entity may have paid or otherwise arranged with the message augmentation system 120 to be selected in cases where it is matched to a shared item along with one or more other business entities.

The augmentation element component 430 may receive information about the matched entity and the shared item and use that information to generate augmentation elements. The augmentation element component 430 may determine an augmentation element associated with the entity and generate an augmented shared item by augmenting the shared item with the augmentation element. Augmentation elements may include control elements and display elements. Display elements may present information about the matched entity. Control elements may, when operated on, cause an action, such as presentation of additional information, navigation to a web page or other network resource, initiation of a phone call, and so forth.

The augmentation element component 430 may access the social network system 220 to obtain information about the entity in order to generate the augmentation elements. For example, the augmentation element component 430 may retrieve a page or profile of the entity and may determine what information is available, such as location, phone number, hours of operation, links to applications ore services associated with the entity, and so forth.

In an embodiment, an entity in the social network system 220 may have one or more bots associated with it. A bot may be able to respond to queries from the augmentation element component 430 to provide entity-related information.

By way of example, when the shared item is a photo item associated with a business or tourism entity by location and/or by keywords, the augmentation element component 430 may generate a display element that presents the entity name, hours of operation, and address. The augmentation element component 430 may generate a control element that opens an ordering page for a business entity, or opens a page for the business entity in the social network system 220.

When the shared item is a link and is associated with an entity by domain name, the augmentation element component 430 may generate a display element that presents information from a website of the entity about the shared item, such as a picture, a description, a price, reviews, and so forth. The augmentation element component 430 may generate a control element that opens an ordering page for the shared item at the web page of the entity, or opens a third-party application that allows ordering or other services to be requested of the entity.

When the shared item is a detected operation or action on a client device, the augmentation element component 430 may generate a display element that presents a suggested application or service related to the operation or action, including an explanation of the relevance of the suggested application or service. The augmentation element component 430 may generate a control element that opens an interface to a software repository where the suggested application or service can be purchased and/or downloaded.

The augmentation element component 430 may assemble the augmentation element(s) into an overlay and attach or append the overlay to the shared item to create an augmented shared item. The augmentation element component 430 may send the augmented shared item to one or more receiving client devices associated with the one or more receiving user accounts via the messaging system 210.

In an embodiment, the augmentation element component 430 may be operative to store generated augmentation elements in association with the matched entity. For example, augmentation element component 430 may store the generated augmentation elements in a data store referenced to the entity. The data store may be a component of the augmentation system 230, or may be a component of the social network system 220.

The object recognition component 440 may use image analytic techniques to identify one or more objects in an image. For example, the object recognition component 440 may identify that an object in an image is a person, an animal, a vehicle, a landmark, a season, or any other object that it has been trained to recognize. The object recognition component 440 may be able to identify specific types of objects, for example, distinguishing a dog from a cat, or a cake from a pie. The object recognition component 440 may receive the shared item from the entity matching component 420 and may return one or more elements, such as keywords describing the recognized object(s), a title or name of a landmark or work of art, or any other information available to the object recognition component 440 from the recognized object(s).

The natural language processing (NLP) component 450 may use natural language processing techniques using machine learning to analyze text-based shared items 130 and generate user intent based on messaging interactions. The entity matching component 420 may request entity information from the natural language processing component 450. The NLP component 450 may analyzes the contents of a messaging interaction to determine an intent of the messaging interaction. The intent represents a goal being sought by the messaging interaction. For instance, people discussing where to get dinner may have an intent of “dining,” “eating,” “restaurant,” or other related term. The entity matching component 420 may provide the content of a messaging interaction, including one or more messages, to the NLP component 450 and may receive the user intent, or multiple user intents, detected for that interaction. The NLP component 450 may be implemented using known natural language processing (NLP) and machine learning (ML) techniques.

FIG. 5 illustrates an embodiment of a messaging system 500 for the system of FIG. 1. The messaging system 500 may be an embodiment of the messaging system 210. It will be appreciated that different distributions of work and functions may be used in various embodiments of a messaging system 500.

The messaging system 500 may comprise a domain name front end 510. The domain name front end 510 may be assigned one or more domain names associated with the messaging system 500 in a domain name system (DNS). The domain name front end 510 may receive incoming connections and distribute the connections to servers providing various messaging services.

The messaging system 500 may comprise one or more chat servers 515. The chat servers 515 may comprise front-end servers for receiving and transmitting user-to-user messaging updates such as chat messages. Incoming connections may be assigned to the chat servers 515 by the domain name front end 510 based on workload balancing.

The messaging system 500 may comprise backend servers 530. The backend servers 530 may perform specialized tasks in the support of the chat operations of the front-end chat servers 515. A plurality of different types of backend servers 530 may be used. It will be appreciated that the assignment of types of tasks to different backend serves 530 may vary in different embodiments. In some embodiments some of the backend services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging system 500 may comprise one or more offline storage servers 531. The one or more offline storage servers 531 may store messaging content for currently-offline messaging endpoints in hold for when the messaging endpoints reconnect.

The messaging system 500 may comprise one or more sessions servers 532. The one or more session servers 532 may maintain session state of connected messaging endpoints.

The messaging system 500 may comprise one or more presence servers 533. The one or more presence servers 533 may maintain presence information for the messaging system 500. Presence information may correspond to user-specific information indicating whether or not a given user has an online messaging endpoint and is available for chatting, has an online messaging endpoint but is currently away from it, does not have an online messaging endpoint, and any other presence state.

The messaging system 500 may comprise one or more push storage servers 534. The one or more push storage servers 534 may cache push requests and transmit the push requests to messaging endpoints. Push requests may be used to wake messaging endpoints, to notify messaging endpoints that a messaging update is available, and to otherwise perform server-side-driven interactions with messaging endpoints.

The messaging system 500 may comprise one or more group servers 535. The one or more group servers 535 may maintain lists of groups, add users to groups, remove users from groups, and perform the reception, caching, and forwarding of group chat messages.

The messaging system 500 may comprise one or more block list servers 536. The one or more block list servers 536 may maintain user-specific block lists, the user-specific incoming-block lists indicating for each user the one or more other users that are forbidden from transmitting messages to that user. Alternatively or additionally, the one or more block list servers 536 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging system 500 may comprise one or more last seen information servers 537. The one or more last seen information servers 537 may receive, store, and maintain information indicating the last seen location, status, messaging endpoint, and other elements of a user's last seen connection to the messaging system 500.

The messaging system 500 may comprise one or more key servers 538. The one or more key servers may host public keys for public/private key encrypted communication.

The messaging system 500 may comprise one or more profile photo servers 539. The one or more profile photo servers 539 may store and make available for retrieval profile photos for the plurality of users of the messaging system 500.

The messaging system 500 may comprise one or more spam logging servers 540. The one or more spam logging servers 540 may log known and suspected spam (e.g., unwanted messages, particularly those of a promotional nature). The one or more spam logging servers 540 may be operative to analyze messages to determine whether they are spam and to perform punitive measures, in some embodiments, against suspected spammers (users that send spam messages).

The messaging system 500 may comprise one or more statistics servers 541. The one or more statistics servers may compile and store statistics information related to the operation of the messaging system 500 and the behavior of the users of the messaging system 500.

The messaging system 500 may comprise one or more web servers 542. The one or more web servers 542 may engage in hypertext transport protocol (HTTP) and hypertext transport protocol secure (HTTPS) connections with web browsers. The one or more web servers 542 may, in some embodiments, host the remote web server 350 as part of the operation of the messaging web access system 100.

The messaging system 500 may comprise one or more chat activity monitoring servers 543. The one or more chat activity monitoring servers 543 may monitor the chats of users to determine unauthorized or discouraged behavior by the users of the messaging system 500. The one or more chat activity monitoring servers 543 may work in cooperation with the spam logging servers 540 and block list servers 536, with the one or more chat activity monitoring servers 543 identifying spam or other discouraged behavior and providing spam information to the spam logging servers 540 and blocking information, where appropriate to the block list servers 536.

The messaging system 500 may comprise one or more sync servers 544. The one or more sync servers 544 may sync the messaging system 540 with contact information from a messaging endpoint, such as an address book on a mobile phone, to determine contacts for a user in the messaging system 500.

The messaging system 500 may comprise one or more multimedia servers 545. The one or more multimedia servers may store multimedia (e.g., images, video, audio) in transit between messaging endpoints, multimedia cached for offline endpoints, and may perform transcoding of multimedia.

The messaging system 500 may comprise one or more payment servers 546. The one or more payment servers 546 may process payments from users. The one or more payment servers 546 may connect to external third-party servers for the performance of payments.

The messaging system 500 may comprise one or more registration servers 547. The one or more registration servers 547 may register new users of the messaging system 500.

The messaging system 500 may comprise one or more voice relay servers 548. The one or more voice relay servers 548 may relay voice-over-internet-protocol (VoIP) voice communication between messaging endpoints for the performance of VoIP calls.

The messaging system 500 may include an authorization server (or other suitable component(s)) (not shown) that allows users to opt in to or opt out of having their actions logged by messaging system 500 or accessed by other systems (e.g., the augmentation system 240, 400), for example, by setting appropriate privacy settings. A privacy setting of a user may determine what information associated with the user may be logged or accessed, how information associated with the user may be logged or accessed, when information associated with the user may be logged or accessed, who may log or access information associated with the user, with whom information associated with the user may be shared, and for what purposes information associated with the user may be logged or accessed. Authorization servers or other authorization components may be used to enforce one or more privacy settings of the users of messaging system 500 and other elements of a social-networking system through blocking, data hashing, anonymization, or other suitable techniques as appropriate.

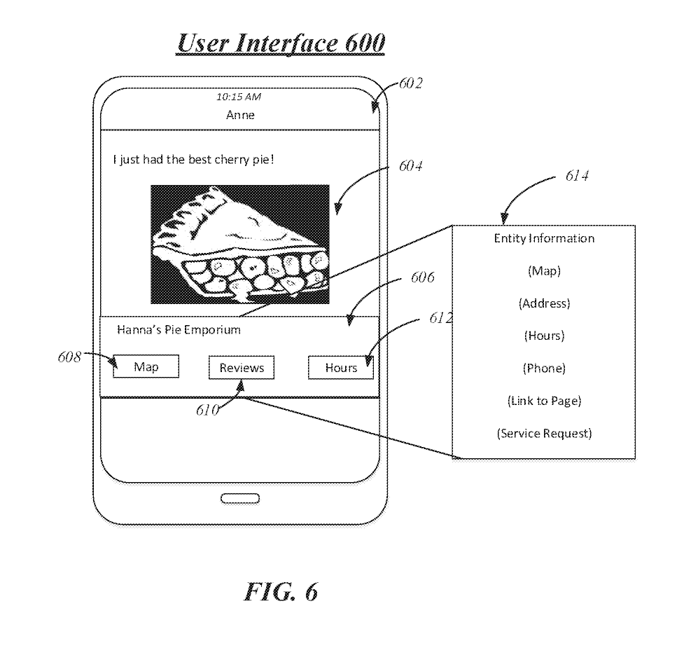

FIG. 6 illustrates an embodiment of a user interface (UI) 600 for the system of FIG. 1. The UI 600 may be presented on a client device 602 within a UI for the message application 320. As shown in FIG. 6, the user of client device 602 has received a message from another user, “Anne”, that includes a shared item 604, which is a photo of a slice of pie. The augmentation system 400, e.g. the message access component 410, may have detected the shared item 604.

In an embodiment, the shared item 604 may have associated metadata including location information about where the photo was taken. The entity matching component 420 may extract the location information. In another embodiment, the shared item 604 may not have any location information associated with it, and the entity matching component 420 may provide the shared item 604 to the object recognition component 440, which may return recognized objects, e.g. “pie”, “dessert”, “pastry.” The entity matching component 420 may use location information about the receiving user and/or the sending user to search for social graph entities having a vicinity that matches the location information and/or that are also associated with the recognized objects. In the illustrated example, the matched entity is “Hanna's Pie Emporium.”

Regardless of the source of the matched entity information, the entity matching component 420 may request augmentation from the augmentation element component 430. The augmentation element component 430 may request and retrieve information about the entity from the social network system 220 and may generate an overlay 606 that includes augmentation elements. For example, the augmentation elements may include a control element 608 and a control element 610. The control element 608 may be a location map retrieval control that, when operated on by a control directive from the user of device 602, causes a map showing the location of the matched entity to be presented on the device 602. The control element 610, when operated on by a control directive, may present consumer or professional reviews associated with the matched entity. Other control elements may include a location messaging contact control for a managing entity associated with a location entity. The augmentation elements may include a display element 612. The display element 612 may present information such as a geographic location for the location entity, a location description, a location rating, location access hours or hours of operation for the matched entity, without being interactive.

In an embodiment, the overlay 606 may itself be a control element that when selected, opens a second overlay 614. The overlay 614 may present display elements and/or control elements about the matched entity. The information presented in overlay 614 may come from an entity page in the social network system 220 and may be a compact representation of the entity page. For example, the overlay 614 may include a map, an address, hours of operation, a telephone number, an email address, a link to the entity page for the entity in the social network system 220, a link to an external web page for the entity, and/or a link to requesting a service from the entity. The embodiments are not limited to these examples. Although the overlay 614 is shown to the side of the device 602 for clarity, in practice, the overlay 614 may be presented within the boundaries of the UI 600 and may obscure some or all of the shared item 604 and/or the overlay 606.

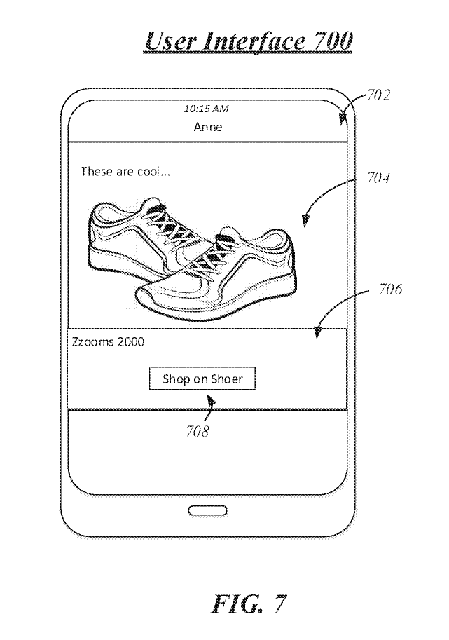

FIG. 7 illustrates an embodiment of a second user interface (UI) 700 for the system of FIG. 1. The UI 700 may be presented on a client device 702 within a UI for the message application 320. As shown in FIG. 7, the user of client device 702 has received a message from another user, “Anne”, that includes a shared item 704, which is a link to an item, shoes, from a commerce website. The augmentation system 400, e.g. the message access component 410, may have detected the shared item 704.

The entity matching component 420 may match the shared item 704 to an entity by matching a domain name of the shared link to the entity in the social network system 220.

The augmentation element component 430 may generate an overlay 706 that includes a control element 708. The control element 708 may link to a service related to the matched entity. In the illustrated example, the control element 708 may open a web page for the matched entity that shows the linked item to enable the user to purchase the item. Control elements for linked shared items may include a product information retrieval control, a product procurement control, a product web page access control, or a business messaging contact control for a business entity associated with the product entity.

In an embodiment, the overlay 706 may also include display elements that present information about the shared item retrieved from the entity, such as a product name, a product description, a product rating, product procurement information, a price, reviews, and so forth. In an embodiment, the overlay 706 may also include display elements and/or control elements that present advertisements or coupons related to the shared item 704 or the matched entity.

When the shared item 704 is a link to a multimedia object, such as a song, a video, or a movie or event preview, the control element 708 may open an application or website that allows the user to consume the multimedia object or to purchase it for download to the device 702, or to purchase tickets to the movie or event.

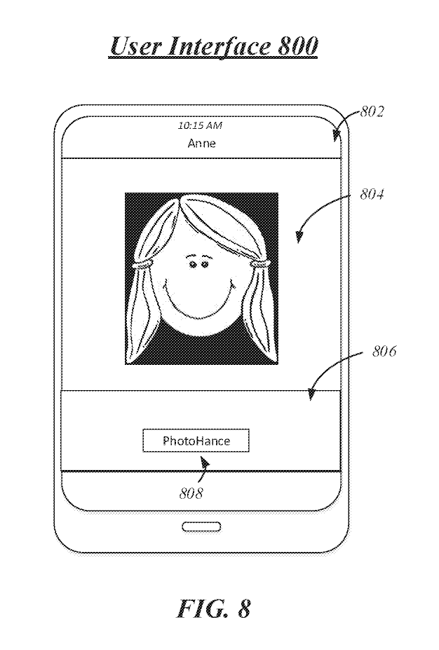

FIG. 8 illustrates an embodiment of a third user interface 800 for the system of FIG. 1. The UI 800 may be presented on a client device 802 within a UI for the message application 320. As shown in FIG. 8, the user of client device 802 is communicating with another user, “Anne”, and has used the camera 304 on the device to take photo 804 of herself to send to Anne. The augmentation system 400, e.g. the message access component 410, may have detected the photo 804 and/or the camera operation in a “selfie” mode.

The entity matching component 420 may match the photo 804 and/or the operation of the camera to an entity in the social network system 220 that provides photo operations, e.g. a media capture application that provides photo enhancements.

The augmentation element component 430 may generate the overlay 806 that includes an augmentation element 808. The augmentation element 808 may be a control element that opens a software storefront for purchasing and downloading the application entity. The augmentation element 808 may be a display element that presents an advertisement for the matched entity.

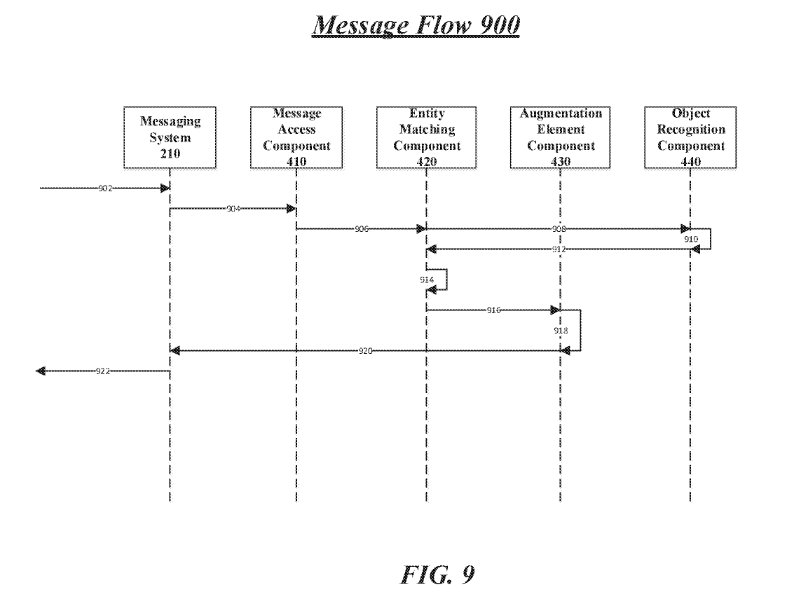

FIG. 9 illustrates an embodiment of a message flow 900 for the system of FIG. 1. The message flow 900 may represent messages communicated among the components of system 100. In particular, the message flow 900 may occur among a messaging system 210 and the components of the augmentation system 400. Message flow 900 may represent messages communicated when a shared image item is sent from a client device. In the illustrated message flow, time flows from the top of the diagram toward the bottom; and a “message” may include data and/or instructions communicated from one component to another, as well as internal functions within a component.

The message flow 900 begins when the messaging system 210 receives a shared item from a client device (not shown), in the message 902. The message 902 may include the shared item and other message elements, such as information that identifies one or more recipient user accounts that are to receive the message, a message thread identifier, information identifying the sender user account where the message 902 originated, and so forth.

The message flow 900 continues when the message access component 410 accesses the message containing the shared item, in the message 904. The message access component 410 may parse or otherwise examine the contents of the received message 902 to identify the shared item. In an embodiment, the messaging system 210 may send the shared item, with or without other message elements, to the message access component 210.

The message flow 900 continues when the message access component 410 requests entity matching from the entity matching component 420, in the message 906. The message 906 may include the shared item and may also include information identifying the sending user account and/or a receiving user account. In the illustrated example, the shared item is an image item.

The message flow 900 continues when the entity matching component 420 requests object recognition from the object recognition component 440, in the message 908. In the illustrated example, the entity matching component 420 does not have sufficient information about the shared image item to perform an entity match. The message 908 may include the shared item.

The message flow 900 continues when the object recognition component 440 performs object recognition, in the message 910. The object recognition component 440 may perform various techniques of image analysis in order to identify what object(s) are represented in the shared image.

The message flow 900 continues when the object recognition component 440 returns the recognized object information to the entity matching component 420, in the message 912. For example, the message 912 may include keywords identifying the object(s) in the shared item. If the object is a landmark or other well-known fixed object, the message 912 may include location information about the object.

The message flow 900 continues when the entity matching component 420 matches the shared item to an entity, in the message 914. The entity matching component 420 may search the social network entities to find one or more entities that match or have a relationship to the recognized object information. In some embodiments, a location of the sender or of the recipient may be used to narrow the search to entities having locations near to the sender or recipient.

The message flow 900 continues when the entity matching component 420 requests an augmented shared item from the augmentation element component 430, in the message 916. The message 916 may include information identifying the matched entity, for example a link to an entity page or profile within the social network system 220.

The message flow 900 continues when the augmentation element component 430 generates augmentation elements, in the message 918. The augmentation element component 430 may retrieve information about the entity from the social network system 220 to generate control and/or display elements about the entity. The augmentation elements (e.g. the control and display elements) may be attached or linked to the shared item so that they can be displayed in an overlay over the shared item.

The message flow 900 continues when the augmentation element component 430 provides the augmented shared item to the messaging system 210, in the message 920. The message 920 may include the augmentation element(s), or may include both the shared item and the augmentation element(s).

The message flow 900 continues when the messaging system 210 sends the augmented shared item to one or more receiving client devices (not shown), in the message 922.

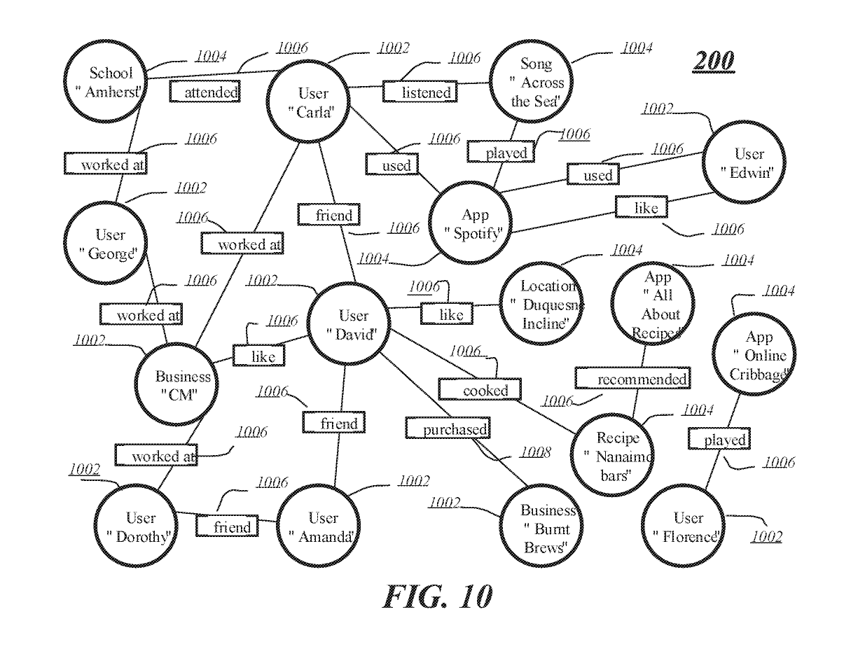

FIG. 10 illustrates an example of a social graph 1000. In particular embodiments, a social-networking system such as social network system 220 may store one or more social graphs 1000 in one or more data stores as a social graph data structure.

In particular embodiments, social graph 1000 may include multiple nodes, which may include multiple user nodes 1002 and multiple concept nodes 1004. Social graph 1000 may include multiple edges 1006 connecting the nodes. In particular embodiments, a social-networking system, client system, third-party system, or any other system or device may access social graph 1000 and related social-graph information for suitable applications. The nodes and edges of social graph 1000 may be stored as data objects, for example, in a data store (such as a social-graph database). Such a data store may include one or more searchable or queryable indexes of nodes or edges of social graph 1000.

In particular embodiments, a user node 1002 may correspond to a user of the social-networking system. As an example and not by way of limitation, a user may be an individual (human user), an entity (e.g., an enterprise, business, or third-party application), or a group (e.g., of individuals or entities) that interacts or communicates with or over the social-networking system. In particular embodiments, when a user registers for an account with the social-networking system, the social-networking system may create a user node 1002 corresponding to the user, and store the user node 1002 in one or more data stores. Users and user nodes 1002 described herein may, where appropriate, refer to registered users and user nodes 1002 associated with registered users. In addition or as an alternative, users and user nodes 1002 described herein may, where appropriate, refer to users that have not registered with the social-networking system. In particular embodiments, a user node 1002 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 1002 may be associated with one or more data objects corresponding to information associated with a user. In particular embodiments, a user node 1002 may correspond to one or more webpages. A user node 1002 may be associated with a unique user identifier for the user in the social-networking system.

In particular embodiments, a concept node 1004 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, government agency, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1004 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1004 may be associated with one or more data objects corresponding to information associated with concept node 1004. In particular embodiments, a concept node 1004 may correspond to one or more webpages.

In particular embodiments, a node in social graph 1000 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 1004. Profile pages may be viewable by all or a selected subset of other users. As an example and not by way of limitation, a user node 1002 may have a corresponding user-profile page in which the corresponding user may add content, make declarations, or otherwise express himself or herself. A business page may comprise a user-profile page for a commerce entity. As another example and not by way of limitation, a concept node 1004 may have a corresponding concept-profile page in which one or more users may add content, make declarations, or express themselves, particularly in relation to the concept corresponding to concept node 1004.

In particular embodiments, a concept node 1004 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 1002 corresponding to the user and a concept node 1004 corresponding to the third-party webpage or resource and store edge 1006 in one or more data stores.

In particular embodiments, a pair of nodes in social graph 1000 may be connected to each other by one or more edges 1006. An edge 1006 connecting a pair of nodes may represent a relationship between the pair of nodes. In particular embodiments, an edge 1006 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 1006 connecting the first user's user node 1002 to the second user's user node 1002 in social graph 1000 and store edge 1006 as social-graph information in one or more data stores. In the example of FIG. 10, social graph 1000 includes an edge 1006 indicating a friend relation between user nodes 1002 of user “Amanda” and user “Dorothy.” Although this disclosure describes or illustrates particular edges 1006 with particular attributes connecting particular user nodes 1002, this disclosure contemplates any suitable edges 1006 with any suitable attributes connecting user nodes 1002. As an example and not by way of limitation, an edge 1006 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1000 by one or more edges 1006.

In particular embodiments, an edge 1006 between a user node 1002 and a concept node 1004 may represent a particular action or activity performed by a user associated with user node 1002 toward a concept associated with a concept node 1004. As an example and not by way of limitation, as illustrated in FIG. 10, a user may “like,” “attended,” “played,” “listened,” “cooked,” “worked at,” or “watched” a concept, each of which may correspond to a edge type or subtype. A concept-profile page corresponding to a concept node 1004 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system may create a “listened” edge 1006 and a “used” edge (as illustrated in FIG. 10) between user nodes 1002 corresponding to the user and concept nodes 1004 corresponding to the song and application to indicate that the user listened to the song and used the application. Moreover, the social-networking system may create a “played” edge 1006 (as illustrated in FIG. 10) between concept nodes 1004 corresponding to the song and the application to indicate that the particular song was played by the particular application. In this case, “played” edge 1006 corresponds to an action performed by an external application (SPOTIFY) on an external audio file (the song “Across the Sea”). Although this disclosure describes particular edges 1006 with particular attributes connecting user nodes 1002 and concept nodes 1004, this disclosure contemplates any suitable edges 1006 with any suitable attributes connecting user nodes 1002 and concept nodes 1004. Moreover, although this disclosure describes edges between a user node 1002 and a concept node 1004 representing a single relationship, this disclosure contemplates edges between a user node 1002 and a concept node 1004 representing one or more relationships. As an example and not by way of limitation, an edge 1006 may represent both that a user likes and has used at a particular concept. Alternatively, another edge 1006 may represent each type of relationship (or multiples of a single relationship) between a user node 1002 and a concept node 1004 (as illustrated in FIG. 10 between user node 1002 for user “Edwin” and concept node 1004 for “SPOTIFY”).

In particular embodiments, the social-networking system may create an edge 1006 between a user node 1002 and a concept node 1004 in social graph 1000. As an example and not by way of limitation, a user viewing a concept-profile page (such as, for example, by using a web browser or a special-purpose application hosted by the user's client system) may indicate that he or she likes the concept represented by the concept node 1004 by clicking or selecting a “Like” icon, which may cause the user's client system to send to the social-networking system a message indicating the user's liking of the concept associated with the concept-profile page. In response to the message, the social-networking system may create an edge 1006 between user node 1002 associated with the user and concept node 1004, as illustrated by “like” edge 1006 between the user and concept node 1004. In particular embodiments, the social-networking system may store an edge 1006 in one or more data stores. In particular embodiments, an edge 1006 may be automatically formed by the social-networking system in response to a particular user action. As an example and not by way of limitation, if a first user uploads a picture, watches a movie, or listens to a song, an edge 1006 may be formed between user node 1002 corresponding to the first user and concept nodes 1004 corresponding to those concepts. Although this disclosure describes forming particular edges 1006 in particular manners, this disclosure contemplates forming any suitable edges 1006 in any suitable manner.

The social graph 1000 may further comprise a plurality of product nodes. Product nodes may represent particular products that may be associated with a particular business. A business may provide a product catalog to a consumer-to-business service and the consumer-to-business service may therefore represent each of the products within the product in the social graph 1000 with each product being in a distinct product node. A product node may comprise information relating to the product, such as pricing information, descriptive information, manufacturer information, availability information, and other relevant information. For example, each of the items on a menu for a restaurant may be represented within the social graph 1000 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 1000. The information for a product node may be manipulated by the social-networking system as a product object that encapsulates information regarding the referenced product.

As used herein, an “entity” that can be matched to a shared item may be any social network object represented by a node in the social graph.

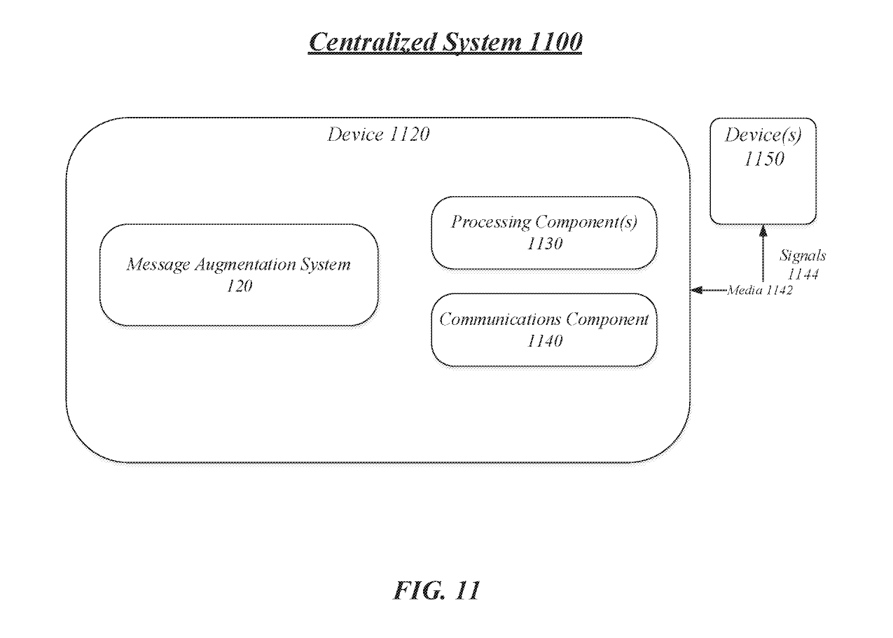

FIG. 11 illustrates a centralized system 1100. The centralized system 1100 may implement some or all of the structure and/or operations for the system 100 for securing delivery of an animated message in a single computing entity, such as entirely within a single device 1120.

The device 1120 may comprise any electronic device capable of receiving, processing, and sending information, and may be an embodiment of a computing device, e.g. a server 400. Examples of an electronic device may include without limitation an ultra-client device, a client device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 1120 may execute processing operations or logic for the system 100 using a processing component 1130. The processing component 1130 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1120 may execute communications operations or logic for the system 100 using communications component 1140. The communications component 1140 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1140 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1142 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1120 may communicate with other devices 1150 over a communications media 1142 using communications signals 1144 via the communications component 1140. The devices 1150 may be internal or external to the device 1120 as desired for a given implementation.

The device 1120 may include within it the message augmentation system 120. Device 1120 may be operative to carry out the tasks of these elements using processing component 1130 and communications component 1140. Devices 1150 may comprise any of devices 110 or 500, the signals 1144 over media 1142 comprising the interactions between the device 1120 and its elements and these respective devices.

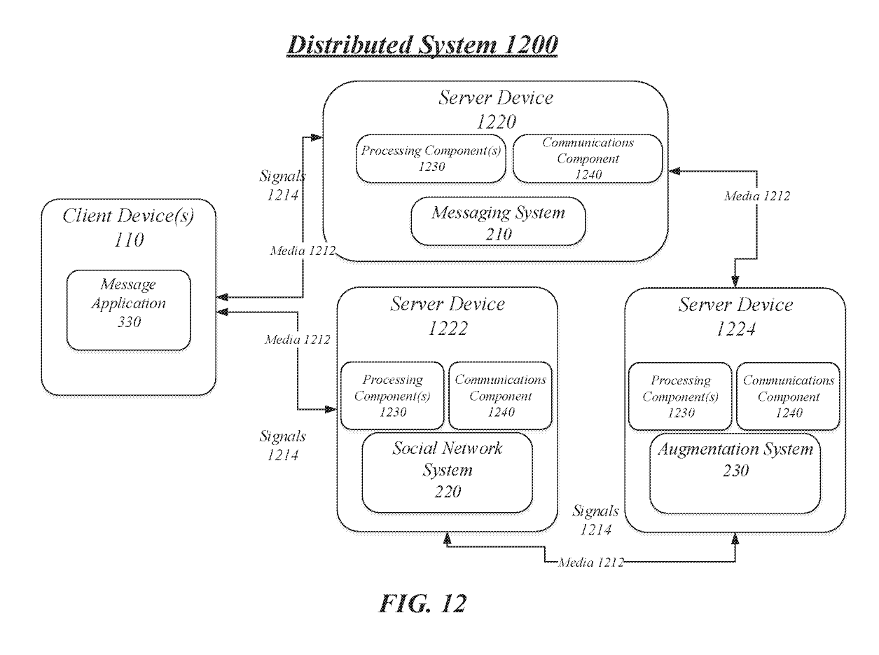

FIG. 12 illustrates an embodiment of a distributed system 1200. The distributed system 1200 may distribute portions of the structure and/or operations for the system 100 across multiple computing entities. Examples of distributed system 1200 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1200 may comprise one or more server devices, such as a server device 1220, server device 1222, and a server device 1224. In general, the server devices 1220, 1222, and 1224 may be similar to the device 1120 as described with reference to FIG. 11. For instance, the server devices 1220 and 1222 may comprise a processing component 1230 and a communications component 1240, which are the same or similar to the processing component 1130 and the communications component 1140, respectively, as described with reference to FIG. 11. In another example, server devices 1220, 1222, and 1224 may communicate over a communications media 1212 using their respective communications signals 1214 via the communications components 1240.

The server device 1220 may comprise or employ one or more server programs that operate to perform various methodologies in accordance with the described embodiments. For example, server device 1220 may implement the messaging system 210. The server device 1222 may comprise or employ one or more server programs that operate to perform various methodologies in accordance with the described embodiments. For example, server device 1222 may implement social network system 220. The server device 1224 may comprise or employ one or more server programs that operate to perform various methodologies in accordance with the described embodiments. For example, server device 1224 may implement augmentation system 230. It will be appreciated a server device 1220, 1222, or 1224—or any of the server devices discussed herein—may itself comprise multiple servers.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

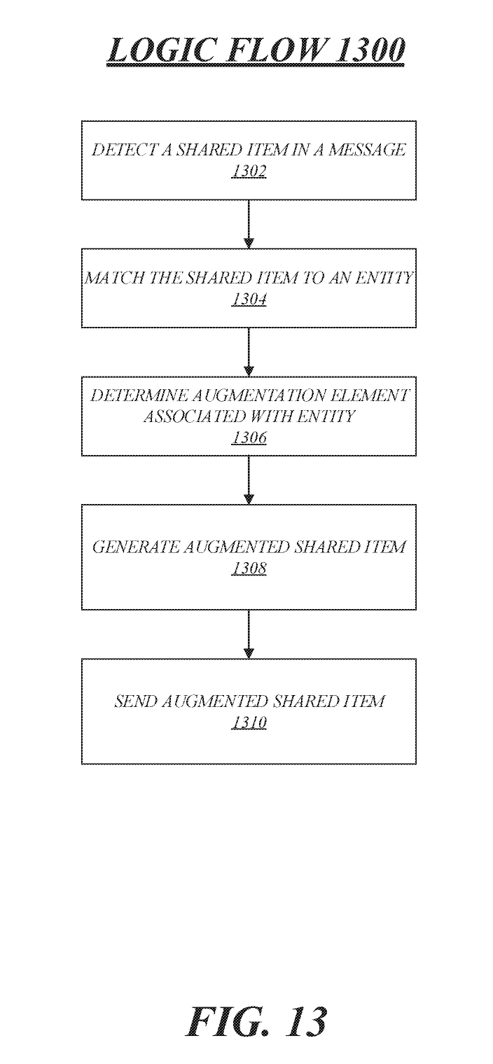

FIG. 13 illustrates an embodiment of a logic flow 1300 for the system 100. The logic flow 1300 may be representative of some or all of the operations executed by one or more embodiments described herein. The operations of the logic flow 1300 may be performed by the message augmentation system 120, for example, by the augmentation system 230 to shared items communicated among users and their devices.

In the illustrated embodiment shown in FIG. 13, the logic flow 1300 may be operative to detect a shared item in a message at block 1302. For example, the message access component 410 may detect shared items within a message sent to the messaging system 210, subject to a user's privacy settings.

The logic flow 1300 may be operative to match the shared item to an entity at block 1304. For example, the entity matching component 420 may identify an entity of the social network system 220 that has some relationship to the shared item.

The logic flow 1300 may be operative to determine augmentation elements associated with the entity at block 1306. For example, the augmentation element component 430 may use information about the entity to generate augmentation elements that provide additional information and/or services related to the entity. The augmentation elements may include control elements and display elements.

The logic flow 1300 may be operative to generate an augmented shared item at block 1308. For example, the augmentation element component 430 may add the augmentation elements to the shared item, e.g. as an overlay, to create an augmented shared item 132.

The logic flow 1300 may be operative to send the augmented shared item to the one or more receiving user accounts at block 1310. For example, the augmentation element component 430 may send the augmented shared item to the messaging system 210 to send to the one or more receiving user accounts indicated by the sending user account in the original message.

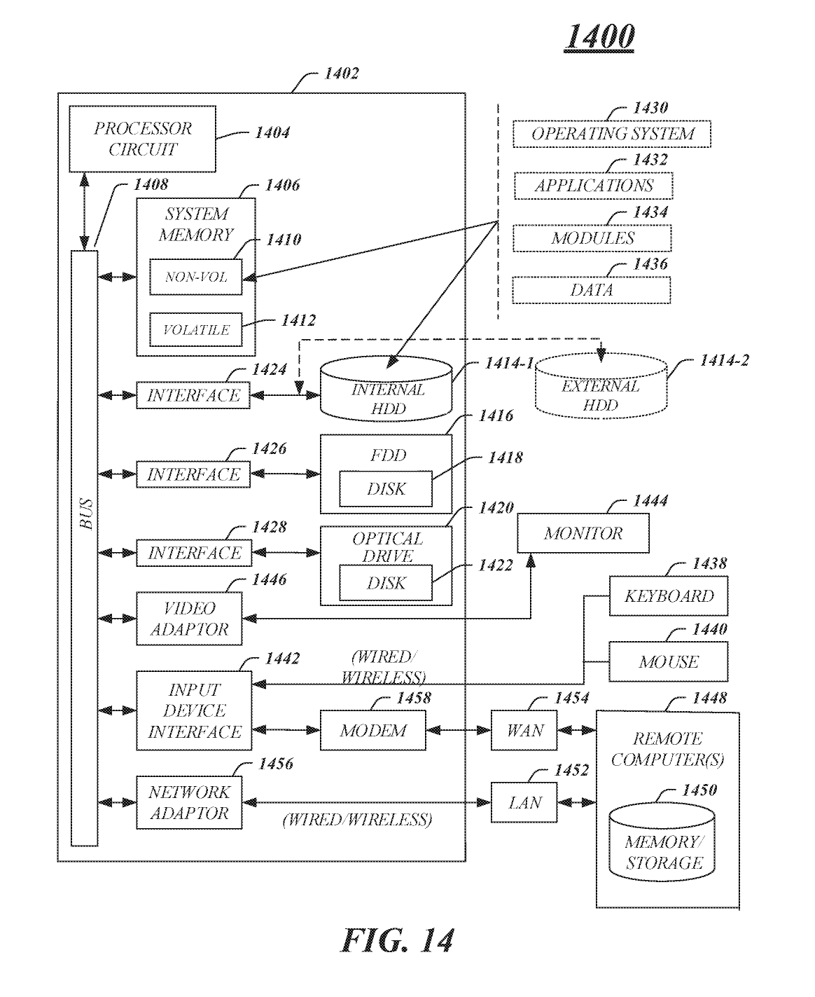

FIG. 14 illustrates an embodiment of an exemplary computing architecture 1400 suitable for implementing various embodiments as previously described. In one embodiment, the computing architecture 1400 may comprise or be implemented as part of an electronic device. Examples of an electronic device may include those described with reference to FIGS. 11-12, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1400.

As shown in FIG. 14, the computing architecture 1400 comprises a processing circuit 1404, a system memory 1406 and a system bus 1408. The processing circuit 1404 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing circuit 1404.

The system bus 1408 provides an interface for system components including, but not limited to, the system memory 1406 to the processing circuit 1404. The system bus 1408 can be any of several types of bus structure that may further interconnect to a memory bus (with or without a memory controller), a peripheral bus, and a local bus using any of a variety of commercially available bus architectures. Interface adapters may connect to the system bus 1408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1406 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1406 can include non-volatile memory 1410 and/or volatile memory 1412. A basic input/output system (BIOS) can be stored in the non-volatile memory 1410.

The computer 1402 may include various types of computer-readable storage media in the form of one or more lower speed memory units, including an internal (or external) hard disk drive (HDD) 1414-1 and 1414-2, respectively, a magnetic floppy disk drive (FDD) 1416 to read from or write to a removable magnetic disk 1418, and an optical disk drive 1420 to read from or write to a removable optical disk 1422 (e.g., a CD-ROM or DVD). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1410, 1412, including an operating system 1430, one or more application programs 1432, other program modules 1434, and program data 1436. In one embodiment, the one or more application programs 1432, other program modules 1434, and program data 1436 can include, for example, the various applications and/or components of the message application 320; and the augmentation system 400.

An operator can enter commands and information into the computer 1402 through one or more wire/wireless input devices, for example, a keyboard 1438 and a pointing device, such as a mouse 1440. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, trackpads, sensors, styluses, and the like. These and other input devices are often connected to the processing circuit 1404 through an input device interface 1442 that is coupled to the system bus 1408, but can be connected by other interfaces such as a parallel port, IEEE 1394 serial port, a game port, a USB port, an IR interface, and so forth.

A monitor 1444 or other type of display device is also connected to the system bus 1408 via an interface, such as a video adaptor 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wired and/or wireless communications to one or more remote computers, such as a remote computer 1448. The remote computer 1448 can be a workstation, a server computer, a router, a personal computer, a portable computer, a microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wired and/or wireless communication network interface or adaptor 1456. The adaptor 1456 can facilitate wired and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired and/or wireless device, connects to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.21 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.21x (a, b, g, n, etc.) to provide secure, reliable, fast wireless connectivity. A Wi-Fi network can be used to connect computers to each other, to the Internet, and to wire networks (which use IEEE 802.3-related media and functions).

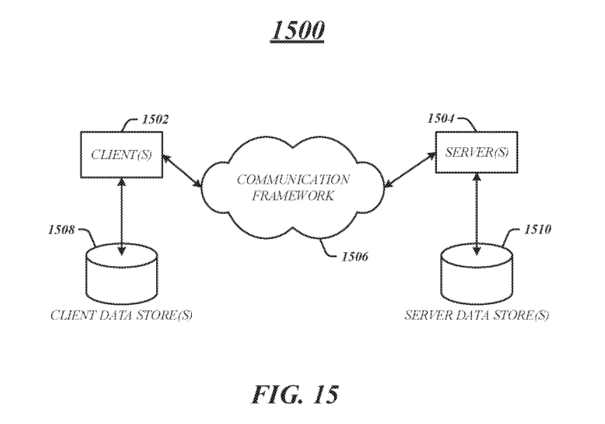

FIG. 15 illustrates a block diagram of an exemplary architecture 1500 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to this implementation by the communications architecture 1500.

As shown in FIG. 15, the communications architecture 1500 comprises one or more clients 1502 and servers 1504. The clients 1502 may implement the devices 110, 300. The servers 1504 may implement the server devices 1120, 1220, 1222, 1224. The clients 1502 and the servers 1504 are operatively connected to one or more respective client data stores 1508 and server data stores 1510 that can be employed to store information local to the respective clients 1502 and servers 1504, such as cookies and/or associated contextual information.

The clients 1502 and the servers 1504 may communicate information among each other using a communication framework 1506. The communications framework 1506 may implement any well-known communications techniques and protocols. The communications framework 1506 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1506 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1502 and the servers 1504. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

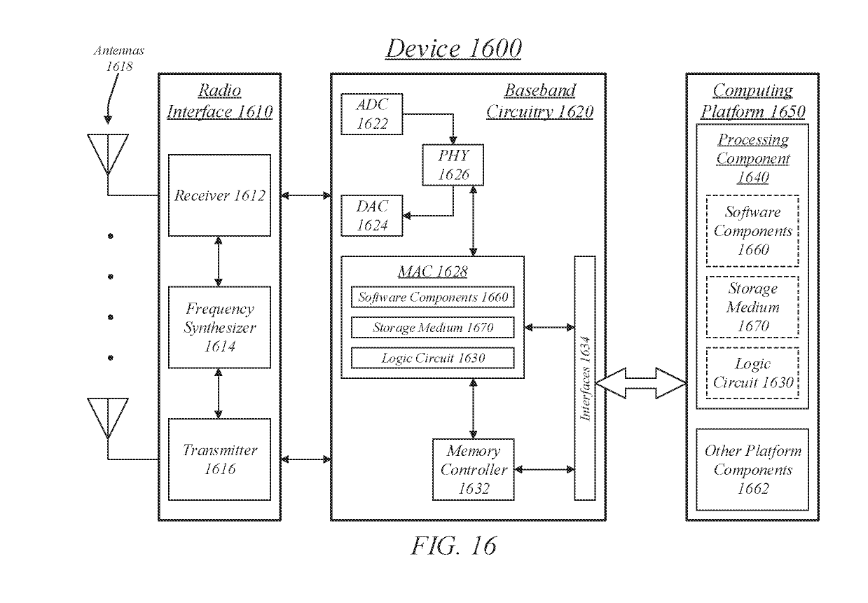

FIG. 16 illustrates an embodiment of a device 1600 for use in a multicarrier OFDM system, such as in the communication system 100. Device 1600 may implement, for example, software components 1660 as described with reference to client device 110, 300 and/or a logic circuit 1630. The logic circuit 1630 may include physical circuits to perform operations described for the client device 110, 300. As shown in FIG. 16, device 1600 may include a radio interface 1610, baseband circuitry 1620, and computing platform 1650, although embodiments are not limited to this configuration.

The device 1600 may implement some or all of the structure and/or operations for the client device 110, 300 and/or logic circuit 1630 in a single computing entity, such as entirely within a single device. Alternatively, the device 1600 may distribute portions of the structure and/or operations for the client device 110, 300 and/or logic circuit 1630 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1610 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1610 may include, for example, a receiver 1612, a transmitter 1616 and/or a frequency synthesizer 1614. Radio interface 1610 may include bias controls, a crystal oscillator and/or one or more antennas 1618. In another embodiment, radio interface 1610 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1620 may communicate with radio interface 1610 to process, receive and/or transmit signals and may include, for example, an analog-to-digital converter 1622 for down converting received signals, a digital-to-analog converter 1624 for up converting signals for transmission. Further, baseband circuitry 1620 may include a baseband or physical layer (PHY) processing circuit 1626 for PHY link layer processing of respective receive/transmit signals. Baseband circuitry 1620 may include, for example, a processing circuit 1628 for medium access control (MAC)/data link layer processing. Baseband circuitry 1620 may include a memory controller 1632 for communicating with processing circuit 1628 and/or a computing platform 1650, for example, via one or more interfaces 1634.

In some embodiments, PHY processing circuit 1626 may include a frame construction and/or detection module, in combination with additional circuitry such as a buffer memory, to construct and/or deconstruct communication frames, such as radio frames. Alternatively or in addition, MAC processing circuit 1628 may share processing for certain of these functions or perform these processes independent of PHY processing circuit 1626. In some embodiments, MAC and PHY processing may be integrated into a single circuit.

The computing platform 1650 may provide computing functionality for the device 1600. As shown, the computing platform 1650 may include a processing component 1640. In addition to, or alternatively, the baseband circuitry 1620, the device 1600 may execute processing operations or logic for the client device 110, 500 and logic circuit 1630 using the processing component 1640. The processing component 1640 (and/or PHY 1626 and/or MAC 1628) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1650 may further include other platform components 1662. Other platform components 1662 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth.

The computing platform 1650 and the baseband circuitry 1620 may further include one or memory units in the form of storage medium 1670. Examples of memory units may include, without limitation. various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1600 may be, for example, an ultra-client device, a client device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1600 described herein, may be included or omitted in various embodiments of device 1600, as suitably desired. In some embodiments, device 1600 may be configured to be compatible with protocols and frequencies associated one or more of the 3GPP LTE Specifications and/or IEEE 802.16 standards for WMANs, and/or other broadband wireless networks, cited herein, although the embodiments are not limited in this respect.

Embodiments of device 1600 may be implemented using single input single output (SISO) architectures. However, certain implementations may include multiple antennas (e.g., antennas 1618) for transmission and/or reception using adaptive antenna techniques for beamforming or spatial division multiple access (SDMA) and/or using MIMO communication techniques.

The components and features of device 1600 may be implemented using any combination of discrete circuitry, application specific integrated circuits (ASICs), logic gates and/or single chip architectures. Further, the features of device 1600 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1600 shown in the block diagram of FIG. 16 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Accordingly, embodiments include methods, apparatuses, and computer-readable storage media for augmenting items shared in a messaging conversation. A computer-implemented method may include detecting a shared item in a message from a sharing user account to a receiving user account; matching the shared item to an entity; determining an augmentation element associated with the entity; generating an augmented shared item by augmenting the shared item with the augmentation element; and sending the augmented shared item to a receiving client device associated with the receiving user account.

The shared item may be a shared link, and the method may further comprise matching the shared item to an entity by matching a domain name for the shared link to the entity.

The shared item may be a shared photo item, and the method may further comprise retrieving a geolocation metadata tag from the shared photo item, the geolocation metadata tag indicating a geographic location; and matching the shared item to an entity by matching the geographic location to a location of the entity.

The shared item may be a shared media item and the method may further comprise submitting the shared media item to an object recognition component; and receiving a recognized product entity from the object recognition module, the entity comprising the recognized product entity.

The shared item may be a shared text message and the method may further comprise submitting the shared text message to a natural-language processing component; receiving a referenced geographic location for the shared text message from the natural-language processing component; and matching the shared item to an entity by matching the referenced geographic location to a location of the entity.

The augmentation element may be a display element or a control element. The entity may be a business entity. A display element may present a business name, a business location, a business description, a business rating, or business hours information; and a control element may present a business information retrieval control or a business messaging contact control.

The method may further include retrieving business information for the one or more display elements from a social-networking page for a business entity.

The entity may be a product entity. A display element may present a product name, a product description, a product rating, or product procurement information; and a control element may present a product information retrieval control, a product procurement control, a product web page access control, or a business messaging contact control for a business entity associated with the product entity.

The product entity may be associated with a plurality of business entities and the method may include selecting the business entity from the plurality of business entities based on a business promotion purchase registration for the business entity.

The entity may be a location entity. A display element may present a geographic location for the location entity, a location description, a location rating, or location access hours information; and a control element may present a location map retrieval control, a location information retrieval control, or a location messaging contact control for a managing entity associated with the location entity.

The method may further include retrieving location information for the one or more display elements from a social-networking page for the location entity.

The shared item may be a shared media item captured by a sharing client device associated with the sharing user account, and the method may further comprise selecting the entity based on the entity being a media capture application.

An apparatus may include a processor circuit on a device; and an augmentation system executing on the processor circuit. The augmentation system may include a message access component operative to detect a shared item in a message from a sharing user account to a receiving user account; an entity matching component operative to match the shared item to an entity; and an augmentation element component operative to determine an augmentation element associated with the entity and to generate an augmented shared item by augmenting the shared item with the augmentation element, and to send the augmented shared item to a receiving client device associated with the receiving user account.

The message access component may detect that the shared item is a shared link, and the entity matching component operative to match the shared item to an entity by matching a domain name for the shared link to a business entity.

The message access component may detect that the shared item is a shared photo item, the entity matching component to retrieve a geolocation metadata tag from the shared photo item, the geolocation metadata tag indicating a geographic location and to match the shared item to an entity by matching the geographic location to a location of the entity.

The message access component may detect that the shared item is a shared media item, the entity matching component to submit the shared media item to an object recognition component, and to receive a recognized product entity from the object recognition module, the entity comprising the recognized product entity.

The message access component may detect that the shared item is a shared text message, the entity matching component to submit the shared text message to a natural-language processing component, receive a referenced geographic location for the shared text message from the natural-language processing component, and to match the shared item to an entity by matching the referenced geographic location to a location of the entity.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
detecting a shared item in a message from a sharing user account to one or more receiving user accounts;
matching the shared item to an entity;
determining an augmentation element associated with the entity;
generating an augmented shared item by augmenting the shared item with the augmentation element; and
sending the augmented shared item to one or more receiving client devices associated with the one or more receiving user accounts.

2. The method of claim 1, the shared item comprising a shared link, further comprising:
matching the shared item to an entity by matching a domain name for the shared link to the entity.

3. The method of claim 1, the shared item comprising a shared photo item, further comprising:
retrieving a geolocation metadata tag from the shared photo item, the geolocation metadata tag indicating a geographic location; and
matching the shared item to an entity by matching the geographic location to a location of the entity.

4. The method of claim 1, the shared item comprising a shared media item, further comprising:
submitting the shared media item to an object recognition component; and
receiving a recognized product entity from the object recognition module, the entity comprising the recognized product entity.

5. The method of claim 1, the shared item comprising a shared text message, further comprising:
submitting the shared text message to a natural-language processing component;
receiving a referenced geographic location for the shared text message from the natural-language processing component; and
matching the shared item to an entity by matching the referenced geographic location to a location of the entity.

6. The method of claim 1, the augmentation element comprising a display element or a control element.

7. The method of claim 6, wherein the entity comprises a business entity, a display element comprising a business name, a business location, a business description, a business rating, or business hours information; and a control element comprising a business information retrieval control or a business messaging contact control.

8. The method of claim 6, wherein the entity comprises a product entity, a display element comprising a product name, a product description, a product rating, or product procurement information; and a control element comprising a product information retrieval control, a product procurement control, a product web page access control, or a business messaging contact control for a business entity associated with the product entity.

9. The method of claim 6, wherein the entity comprises a location entity, a display element comprising a geographic location for the location entity, a location description, a location rating, or location access hours information; and a control element comprising a location map retrieval control, a location information retrieval control, or a location messaging contact control for a managing entity associated with the location entity.

10. An apparatus, comprising:
a processor circuit on a device;
an augmentation system executing on the processor circuit, the augmentation system comprising:
a message access component operative to detect a shared item in a message from a sharing user account to one or more receiving user accounts;
an entity matching component operative to match the shared item to an entity; and
an augmentation element component operative to determine an augmentation element associated with the entity and to generate an augmented shared item by augmenting the shared item with the augmentation element, and to send the augmented shared item to one or more receiving client devices associated with the one or more receiving user accounts.

11. The apparatus of claim 10, the message access component to detect that the shared item is a shared link, and the entity matching component operative to match the shared item to an entity by matching a domain name for the shared link to a business entity.

12. The apparatus of claim 10, the message access component to detect that the shared item is a shared photo item, the entity matching component to retrieve a geolocation metadata tag from the shared photo item, the geolocation metadata tag indicating a geographic location and to match the shared item to an entity by matching the geographic location to a location of the entity.

13. The apparatus of claim 10, the message access component to detect that the shared item is a shared media item, the entity matching component to submit the shared media item to an object recognition component, and to receive a recognized product entity from the object recognition module, the entity comprising the recognized product entity.

14. The apparatus of claim 10, the message access component to detect that the shared item is a shared text message, the entity matching component to submit the shared text message to a natural-language processing component, receive a referenced geographic location for the shared text message from the natural-language processing component, and to match the shared item to an entity by matching the referenced geographic location to a location of the entity.

15. At least one computer-readable storage medium comprising instructions that, when executed, cause a system to:
detect a shared item in a message from a sharing user account to one or more receiving user accounts;
match the shared item to an entity;
determine an augmentation element associated with the entity;
generate an augmented shared item by augmenting the shared item with the augmentation element; and
send the augmented shared item to one or more receiving client devices associated with the one or more receiving user accounts.

16. The computer-readable storage medium of claim 15, comprising further instructions that, when executed, cause the system to:
detect a shared link as the shared item; and
match the shared item to an entity by matching a domain name for the shared link to the entity.

17. The computer-readable storage medium of claim 15, comprising further instructions that, when executed, cause the system to:
detect a shared photo item as the shared item;
retrieve a geolocation metadata tag from the shared photo item, the geolocation metadata tag indicating a geographic location; and
match the shared item to an entity by identifying an entity having a location within a vicinity of the geographic location.

18. The computer-readable storage medium of claim 15, wherein the entity comprises a business entity, comprising further instructions that, when executed, cause the system to:
determine an augmentation element comprising a display element presenting a business name, a business location, a business description, a business rating, or business hours information; or
determine an augmentation element comprising a control element presenting a business information retrieval control or a business messaging contact control.

19. The computer-readable storage medium of claim 15, wherein the entity comprises a product entity, comprising further instructions that, when executed, cause the system to:
determine an augmentation element comprising a display element presenting a product name, a product description, a product rating, or product procurement information; or
determine an augmentation element comprising a control element presenting a product information retrieval control, a product procurement control, a product web page access control, or a business messaging contact control for a business entity associated with the product entity

20. The computer-readable storage medium of claim 15, wherein the entity comprises a location entity, comprising further instructions that, when executed, cause the system to:
determine an augmentation element comprising a display element presenting a geographic location for the location entity, a location description, a location rating, or location access hours information; or
determine an augmentation element comprising a control element presenting a location map retrieval control, a location information retrieval control, or a location messaging contact control for a managing entity associated with the location entity.
